(19) United States
(12) Patent Application Publication
(10) Pub. No.: US 2021/0263621 A1
(43) Pub. Date: Aug. 26, 2021

(54) SYSTEMS AND METHODS FOR AN INTELLIGENT ANALYTIC PLATFORM

(71) Applicant: Eisengard AI Incorporated, New York, NY (US)

(72) Inventors: Clarence Lee, Ithaca, NY (US); Anoop Menon, New York, NY (US)

(21) Appl. No.: 17/318,369

(22) Filed: May 12, 2021

Related U.S. Application Data
(60) Provisional application No. 63/025,857, filed on May 15, 2020.

(51) Int. Cl. G06F 3/0481; G06F 9/451

(52) U.S. Cl. CPC G06F 3/0481; G06F 9/451

(57) ABSTRACT

The present disclosure provides an intelligent analytic platform. The platform comprises: an electronic display with a user interface comprising: (i) a plurality of graphical virtual cards corresponding to a plurality of analyses and insights and (ii) an interactive framework; a memory for storing a set of software instructions, and one or more processors configured to execute the set of software instructions to: link at least one of the plurality of graphical virtual cards to an interactive component of the framework; and output an analytic solution of the framework.

### CROSS-REFERENCE TO RELATED APPLICATION

This application claims priority to U.S. Provisional Patent Application No. 63/025,857, filed May 15, 2020, wherein the entire disclosure of the foregoing application is hereby incorporated by reference herein.

### BACKGROUND

Data analysis systems and methods have been developed to translate data into meaningful and actionable information to assist in making data-driven decisions. However, making sense of the enormous size, speed and variety of data available to companies or enterprises is challenging. For example, making high-quality data-driven decisions may take time to process data and the process can be slow. In order to achieve this synthesis of quality and speed, it is desired to provide an optimized data analysis and insight communication workflow to improve the decision-making quality and speed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein) of which:

FIG. 1 shows an environment in which an intelligent data analytic platform of the present disclosure may operate;

FIG. 2 schematically illustrates an example of the intelligent data analytic platform facilitating collaborations and communications among various parties across data sides and business sides;

FIG. 3 schematically illustrates an example of the platform workflow;

FIG. 4 shows an example of a digital virtual card for insight and recommendations;

FIG. 5 shows an exemplary GUI of a dashboard for managing and viewing a plurality of insights virtual cards;

FIG. 6 shows an example of sharing a virtual card;

FIG. 7A shows an exemplary GUI for creating a story;

FIG. 7B shows example “slides” of a lightweight story in fullscreen mode;

FIG. 7C shows an example of a slide of a story;

FIG. 8 shows examples of created stories;

FIG. 9 and FIG. 10 show exemplary GUIs of story dashboard for managing and organizing stories;

FIG. 11 shows examples of GUIs for KPI stream;

FIG. 12 shows examples of virtual cards pinned to a KPI stream dashboard;

FIG. 13 shows an example of an analysis image creator panel;

FIGS. 14-18 show various of different frameworks; and

FIG. 19 shows an example of linking one or more insight cards/analyses to an existing framework.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Certain Definitions

Unless otherwise defined, all technical terms used herein have the same meaning as commonly understood by one of ordinary skill in the art to which this invention belongs.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Current data analytic systems or business intelligence platform may not be able to provide satisfactory user experience. For instance, users may suffer from slow decision-making process, poor data quality, difficulty to adopt new business intelligent platform, or difficulty to scale existing solution or platform. Creating and executing to a relevant, coherent and agile strategy in a meaningful and efficient way remains a challenge. Current data analytic platforms may not permit a user to seamlessly and intuitively derive comprehensive and holistic business strategies in an automated and/or interactive fashion. In some circumstances, existing methods may not be able to provide business strategies or data-driven decisions in substantially real-time. Moreover, existing platforms may lack of a standardized strategy modelling framework and toolset that can utilize this information, correlate it with internal activity and present the implications in a meaningful way to executive management to prepare responses.

The present disclosure provides an intelligent data analytic platform addressing the above needs by leveraging data analysis, predictive analysis, machine learning-based auto-processing and insight extraction. The intelligent data analytic platform may be an integrated, automated and intelligent application system or data analytic platform. Such application or platform may be capable of devising and generating organizational strategies in real-time while understanding the implications of decisions, consumer trends, technology disruptions, competitor threats and the like.

In some embodiments of the intelligent data analytic platform, standardized analyses may be provided to improve analytics speed, deployment and scaling. For example, the intelligent data analytic platform may be capable of converting performance or marketing analyses and models in varied formats into a standardized analytics suite that can perform a variety of performance and marketing analyses rapidly and reliably. Additionally, the intelligent data analytic platform of the present disclosure may provide an intuitive and easy user interface allowing for creation and sharing of insights in a standardized format that are concise, comprehensive, and actionable.

Moreover, the provided intelligent data analytic platform may provide workflow with iterations and feedback to achieve high-quality insights. The feedback communication and iterations may be performed in a seamlessly and lightweight fashion enabled by the integrated intelligent data analytic platform such that users (e.g., decision makers) may share information rapidly and iterate the process, to quickly converge on ground truths and increase quality of the decisions. In some embodiments, the intelligent data analytic platform can be conveniently integrated into existing workflows or applications with improved flexibility. For instance, users (e.g., analytic teams) may be permitted to easily and rapidly share insights from their existing models and dashboards, amplifying their effectiveness by delivering these insights to the decision makers in real-time through the interactive framework. The provided intelligent data analytic platform may beneficially allow users (e.g., analytics teams) to leverage and extend their existing analytic capabilities.

The present disclosure provides systems and methods for an integrated and intelligent data analytic platform. Systems and methods provided herein may be a platform as a service (PaaS) and/or software-as-a-service (SaaS) applications configured for providing a suite of pre-built, cross-industry applications, developed on its platform, that facilitate IoT business transformation for organizations in energy, manufacturing, aerospace, automotive, chemical, pharmaceutical, telecommunications, retail, insurance, healthcare, financial services, the public sector, and others.

In some embodiments of the present disclosure, one or more modules/components of the provided analytic data platform may employ artificial intelligence techniques to perform predictive analysis, insight extraction, optimizing workflow and the like. A machine learning algorithm may be reinforcement learning, supervised learning or unsupervised learning.

### Intelligent Data Analytic Platform

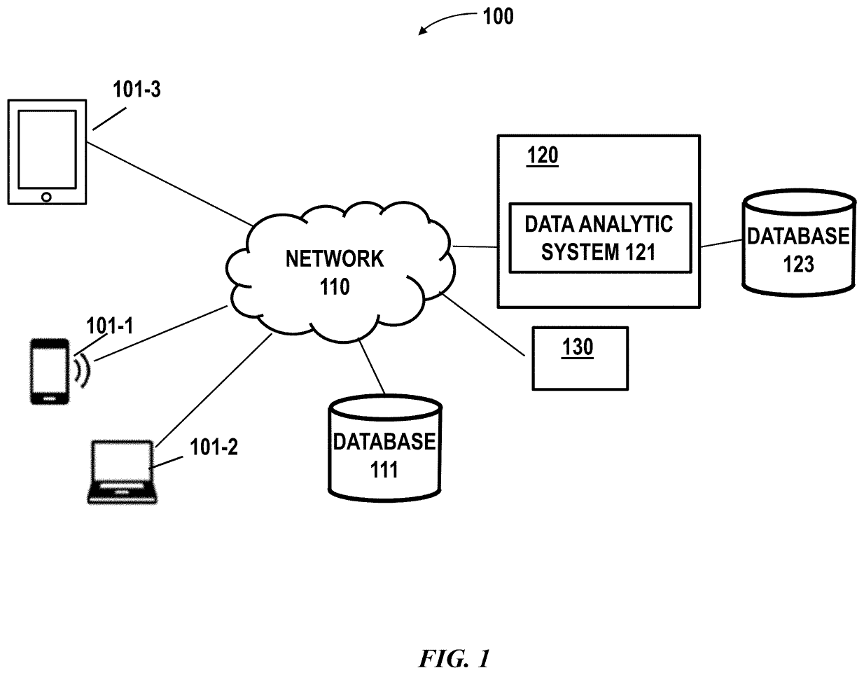

FIG. 1 shows an environment in which the intelligent data analytic platform of the present disclosure may operate. The platform 100 may include a data analytic system 121 interacting with one or more user devices 101-1, 101-2, 101-3, and one or more third-party systems 130 (e.g., existing analytic/management system) through one or more communication networks 110. The data analytic system may also be referred to as intelligent data analytic platform throughout the disclosure.

In some embodiments, the data analytic system 101 may be configured to provide organizational strategies in real-time while understanding the implications of decisions, consumer trends, technology disruptions, competitor threats and the like. In some cases, the data analytic system may include an analytics engine that can perform historical analyses, predictive analyses, optimization, segmentation, matched market experimentation or other analyses. The analyses, models and/or the input data may be converted to a standard format by the data analytic system 101 allowing for rapid deployment of these models and automating the data processing processes.

In some cases, the data analytic system 101 may include a plurality of components such as data-driven collaboration and decision-making through standardization and iteration, real-time streaming of analytic key performance indicators (KPI) and customized analytics dashboards and analytics-powered system-level overview through frameworks. The data analytic platform may comprise multiple modules (e.g., standard virtual card for insights or stories, KPI streaming, dashboard, framework module, etc.) related to various aspects of a strategy framework. Each of the multiple modules may be a self-contained module that can be independently operated and worked on by different users concurrently. The architecture of data analytic platform and its various objects are described later herein.

The data analytic system 121 may comprise servers 120 and database systems 111, 123, which may be configured for collecting or retrieving relevant information. Relevant information may include, for example, industry trends, market conditions, data on company's assets such as technology assets (e.g., application data), resources (e.g., supplier data), processes (e.g., program and project data), organizational activities (e.g., HR data) and various others. Each of the components (e.g., servers, database systems, user devices, and the like) may be operatively connected to one another via network 110 or any type of communication links that allows transmission of data from one component to another. For instance, the servers and database systems may be in communication—via the network 110—with the user devices 101-1, 101-2, 101-3 and/or data sources to obtain relevant data, for example.

The data sources may include systems, nodes, or devices in a computing network or other systems used by an enterprise, company, customer or client, or other entities. In an example, the data sources may include a database of customer or company information. The data sources may include data stored in an unstructured database or format, such as a Hadoop distributed file system (HDFS). The data sources may include data stored by a customer system, such as a customer information system (CIS), a customer relationship management (CRM) system, or a call centre system. The data sources may include data stored or managed by an enterprise system, such as a billing system, financial system, supply chain management (SCM) system, asset management system, and/or workforce management system. The data sources may include data stored or managed by operational systems, such as a distributed resource management system (DRMS), document management system (DMS), content management system (CMS), energy management system (EMS), geographic information system (GIS), globalization management system (GMS), and/or supervisory control and data acquisition (SCADA) system. The data sources may include social media data such as data from Facebook®, LinkedIn®, Twitter®, or other social network or social network database.

Such data may be managed and stored in the databases of the data analytic platform. In some cases, at least a portion of the data may be manually inputted by a user using a standard format. In some cases, at least a portion of the data may be automatically converted to a standard format and ingested into the database. In some cases, at least a portion of the data is obtained without human intervention. For instance, data scraping techniques may be utilized to extract data from websites and the frequency of data scraping and which websites to parse may be determined by the system.

A server 120 may include a web server, an enterprise server, or any other type of computer server, and can be computer programmed to accept requests (e.g., HTTP, or other protocols that can initiate data transmission) from a computing device (e.g., user device and/or wearable device) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include various computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

The one or more databases may utilize any suitable database techniques. For instance, structured query language (SQL) or “NoSQL” database may be utilized for storing collected device data, enterprise data, organization data, and generated analytics. Some of the databases may be implemented using various standard data-structures, such as an array, hash, (linked) list, struct, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the data analytic system 121 may construct the database in order to deliver the data to the users efficiently. For example, the data analytic system may provide customized algorithms to extract, transform, and load (ETL) the data. In some embodiments, the data analytic system may construct the databases using proprietary database architecture or data structures to provide an efficient database model that is adapted to large scale databases, is easily scalable, is efficient in query and data retrieval, or has reduced memory requirements in comparison to using other data structures.

The data analytic system 121 may be implemented anywhere in the network. The data analytic system 121 may be implemented on one or more servers in the network, in one or more databases in the network, or one or more user devices. The data analytic system 121 may be implemented using software, hardware, or a combination of software and hardware in one or more of the above-mentioned components within the platform 100.

In some embodiments, one or more systems or components of the present disclosure are implemented as a containerized application (e.g., application container or service containers). The application container provides tooling for applications and batch processing such as web servers with Python or Ruby, JVMs, or even Hadoop or HPC tooling. Application containers are what developers are trying to move into production or onto a cluster to meet the needs of the business. Methods and systems of the invention may be described with reference to embodiments where container-based virtualization (containers) is used. The methods and systems can be implemented in application provided by any type of systems (e.g., containerized application, unikernel adapted application, operating-system-level virtualization or machine level virtualization).

User device 101-1, 101-2, 101-3 may be a computing device configured to perform one or more operations consistent with the disclosed embodiments. Examples of user devices may include, but are not limited to, mobile devices, smartphones/cellphones, tablets, personal digital assistants (PDAs), laptop or notebook computers, desktop computers, media content players, television sets, video gaming station/system, virtual reality systems, augmented reality systems, microphones, or any electronic device configured to enable the user to interact with a graphical user interface provided by the data analytic system. The user device may be a handheld object. The user device may be portable. The user device may be carried by a human user. In some cases, the user device may be located remotely from a human user, and the user can control the user device using wireless and/or wired communications.

The user device may include a communication unit, which may permit the communications with one or more other components in the network. In some instances, the communication unit may include a single communication module, or multiple communication modules. In some instances, the user device may be capable of interacting with one or more components in the network environment using a single communication link or multiple different types of communication links. The user devices may interact with the data analytic system by requesting and obtaining the aforementioned data via the network 110.

User device may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations.

In some embodiments, users may utilize the user devices to interact with the data analytic system 121 by way of one or more software applications (i.e., client software) running on and/or accessed by the user devices, wherein the user devices and the data analytic system may form a client-server relationship. For example, the user devices may run dedicated applications associated with the strategy application system and/or utilize one or more browser applications to access insights, stories, framework, analytics data, or business strategy related information. In turn, the data analytic system 121 may deliver information and content to the user devices related to insight, business strategies, analysis, statistics, consulting strategies, for example, by way of one or more web pages, desktop applications, or pages/views of a mobile application.

In some embodiments, the client software (i.e., software applications installed on the user devices) may be available either as downloadable applications for various types of user devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms.

User device may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). For example, a user interface (UI) module may provide a UI for representing an interactive insight or story card to a user and receiving user input (e.g., through user interface running on the user device). The user interface may comprise using of one or more user interactive device (e.g., mouse, joystick, keyboard, trackball, touchpad, button, verbal commands, gesture-recognition, attitude sensor, thermal sensor, touch-capacitive sensors, AR or VR devices).

The GUI may show graphical elements that permit a user to view or access information related to the organization business. The user device may also be configured to display webpages and/or websites on the Internet. One or more of the webpages/websites may be hosted by a server in the network or the intelligent data analytic platform.

In some cases, the user device may be coupled to a viewing device. The viewing device may comprise a display screen or is a wearable augmented reality device that displays a three-dimensional view. The three-dimensional view may be a first person view or is an augmented reality view comprising analytics (e.g., diagrams, charts, etc.) provided by the intelligent data analytic platform.

User devices may be associated with one or more users. In some embodiments, a user may be associated with a unique user device. Alternatively, a user may be associated with a plurality of user devices. A user as described herein may refer to an individual or a group of individuals who are seeking data analytic information or performing data analyses enabled by the intelligent data analytic platform.

The network 110 may be a communication pathway between the data analytic system 121, the user devices, existing/third-party systems, other components of the network. The network may comprise any combination of local area and/or wide area networks using both wireless and/or wired communication systems. For example, the network 110 may include the Internet, as well as mobile telephone networks. In one embodiment, the network 110 uses standard communications technologies and/or protocols. Hence, the network 110 may include links using technologies such as Ethernet, 802.11, worldwide interoperability for microwave access (WiMAX), 2G/3G/4G/5G or Long Term Evolution (LTE) mobile communications protocols, Infra-Red (IR) communication technologies, and/or Wi-Fi, and may be wireless, wired, asynchronous transfer mode (ATM), InfiniBand, PCI Express Advanced Switching, or a combination thereof. Other networking protocols used on the network 130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. The network may be wireless, wired, or a combination thereof.

In some embodiments, the intelligent data analytic platform may provide a user interface for presenting insights, analyses results, stories, framework or business strategy information to the user while allowing for customizing the frameworks, dashboards, insights and stories via user interaction. The user interface in some cases is a graphical user interface (GUI). Various examples of GUIs for user with systems provided herein are described later.

While graphical user interfaces have been described with reference to various figures, it will be appreciated that such descriptions are illustrative and non-limiting. Graphical user interfaces with other features and configurations can be used with systems and methods provided herein.

In some embodiments, the intelligent data analytic platform may be an integrated platform allowing for communication and collaboration across different teams (e.g., data engineers, data scientists, data insights managers, performance marketers, brand managers, etc.), business units, organizations, or industries.

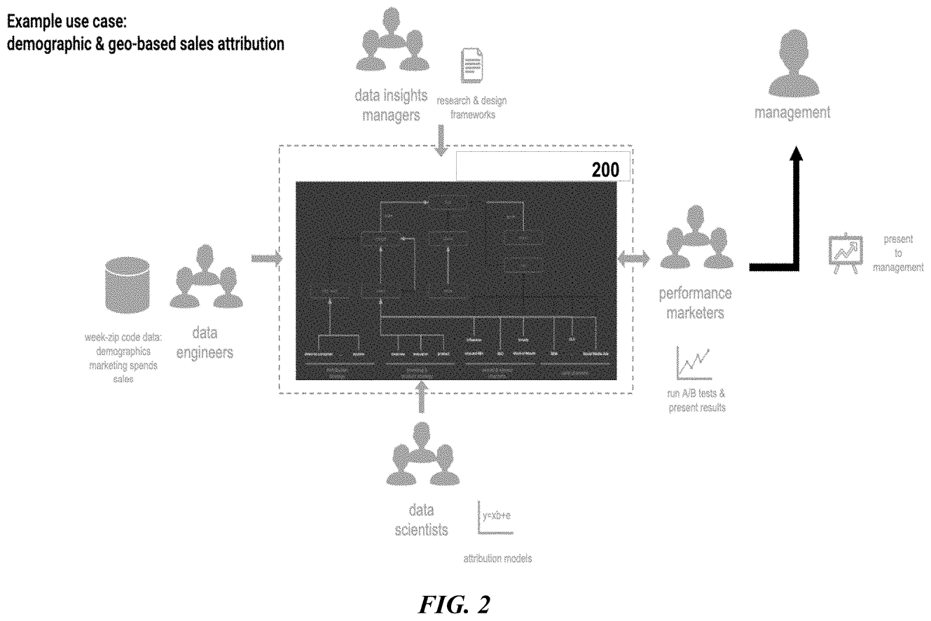

FIG. 2 schematically illustrates an example of the intelligent data analytic platform 200 facilitating collaborations and communications among various parties across data sides and business sides. As described above, the intelligent data analytic platform may allow for communication and collaboration across different teams from the data sides such as data engineers, data scientists to the business sides such as data insights managers, performance marketers, brand managers and the like. This may beneficially provide a decentralized environment allowing people to work on a modular of a framework in parallel and dynamically link the modular tasks to the framework to deliver a final solution. The intelligent data analytic platform may, for example, allow users to join in a one centralized space where they can communicate and coordinate over experiments that are guided by data-driven insights. The users may iteratively build towards a comprehensive picture and deliver a real-time feed or solution.

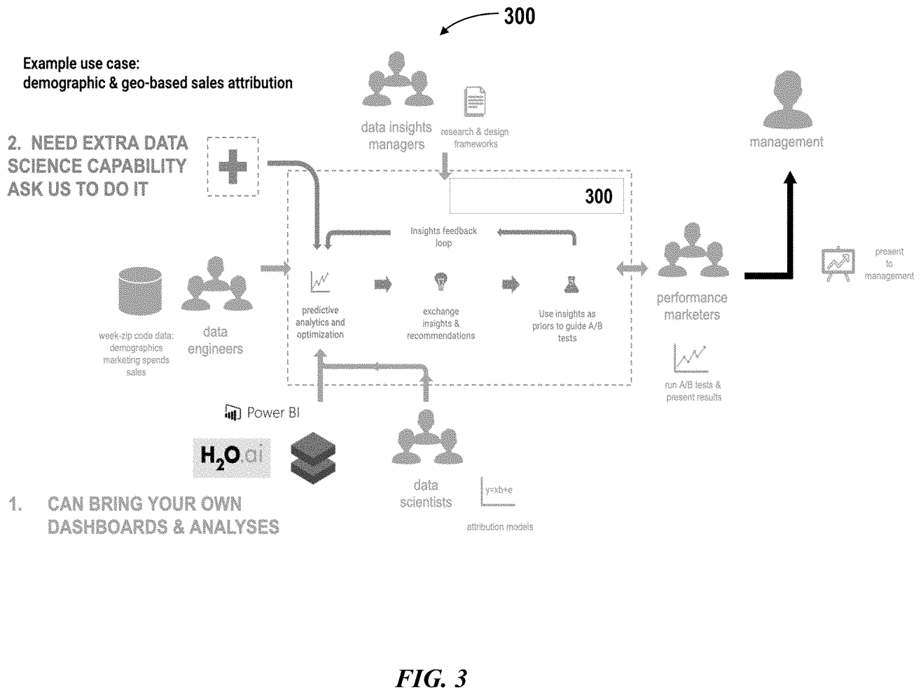

FIG. 3 schematically illustrates an exemplary platform workflow 300. In the illustrated example, the intelligent data analytic platform may provide an optimized workflow with insight feedback loop. For instance, as illustrated in the example, the intelligent data analytic platform may guide and manage the data-driven decision making process by automatically ingesting data from predictive analytics and optimization and/or other data sources, allowing users to exchange insights and recommendations using the standardized insight and stories module, and using the insights as priors to guide agile tests (e.g., AB tests). The process may be iterated (i.e., insights feedback loop) to converge and output a final solution.

The intelligent data analytic platform may advantageously allow users to both (1) leverage their own dashboards and analyses (e.g., bring-your-own dashboards and analyses module) and (2) increase extra data science capabilities by utilizing on-demand data science consulting. The intelligent data analytic platform may provide flexibility in terms of forms of data and the integration method. Data, components, analyses, modules or functions may be uploaded or integrated into the intelligent data analytic platform in a frictionless manner.

In some cases, the intelligent data analytic platform may include a data input module configured to receive user input data in any format such as an image of text/charts (e.g., screenshot) or other forms. The data input module may utilize any suitable techniques such as optical character recognition (OCR) or transcription to extract the analyses data. For instance, users may be permitted to input their own analyses as easily as capturing a screenshot. Additionally, users may request data science analyses or functions through the intelligent analytic platform. This may advantageously provide modular components and features to the platform thereby improving the flexibility in deployment and customization.

The intelligent data analytic platform may comprise a plurality of modules related to data-driven collaboration, decision-making, insight, recommendation, streaming performance measurements (e.g., key performance indicator), or modular framework modules. In some cases, a module may include a graphical user interface (GUI), allowing users to interact with the data analyses and the set of features of each module.

### Standardization and Iteration Module

In some embodiments, the intelligent data analytic platform may comprise a module for data-driven collaboration and decision-making through standardization and iteration. In some cases, a digital virtual card may be provided to assist collaboration and the workflow of decision-make in a standardized format. The digital virtual card may beneficially provide modularity to the system such that analyses and insights can be easily integrated to dashboard, framework, stories, other modules, data structures or existing frameworks thereby allowing for flexibility in optimizing workflow and/or customizing framework. In some embodiments, the digital virtual card may be an interactive graphical component including diagrams (e.g., graph), editable fields for insight, recommendation, and title of the virtual card.

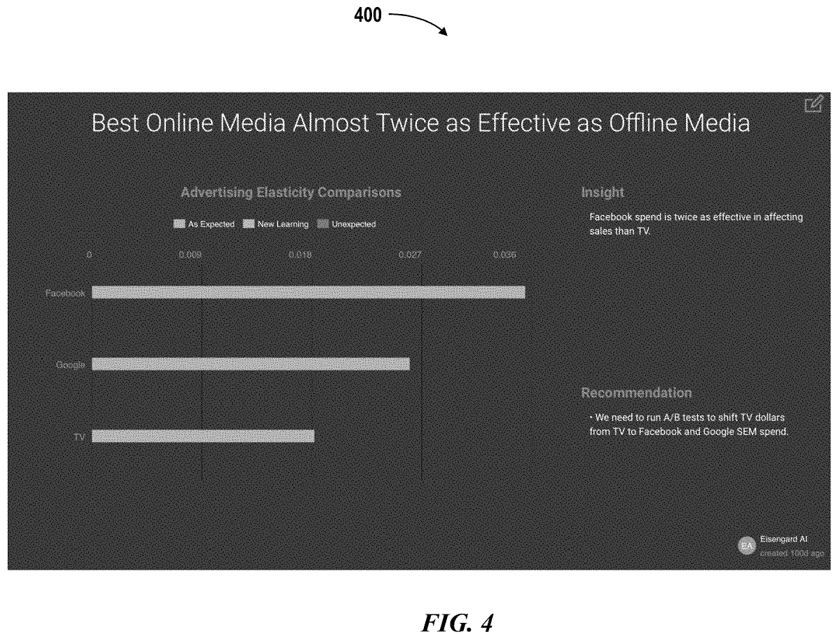

FIGS. 4-10 show various examples of user interfaces or digital virtual cards in accordance with some embodiments of the present disclosure. In some cases, the digital virtual card may be used for users to create, edit, record, and share insights and stories in a standardized template. The digital virtual card may include graphical user interface (GUI) that may permit various input methods (e.g., swipe, click, voice command, text search, etc.) for a user to interact with one or more components of the interactive digital virtual card to create, edit a text field (e.g., insight field, recommendation field, title field), view detailed information (e.g., graph of an analysis) and the like. The digital virtual card may include components such as a graph of an analysis result, and insight and recommendation created on the analysis. In some cases, an insight virtual card may correspond to an analysis.

FIG. 4 shows an example of a digital virtual card 400 for creating insight and recommendations. A user may create, edit insight and/or recommendations via a graphical user interface (GUI) of the digital virtual card. The digital virtual card may include a title (e.g., “best online media almost twice as effective as office media”) of the analysis, a graph (e.g., advertising elasticity comparison) of an analysis, and insight and recommendation created on the graph. The digital virtual card may have a concise layout such that the elements and information may fit within the same region.

In some cases, the digital virtual card may have at least an editing mode and a view mode. A user may switch between the two modes by clicking on the “edit” icon to create, edit the insight, title, recommendation or a display of the graph in the digital virtual card. In some cases, the graph may be an analysis result generated automatically by the analytic engine of the system. A user may be permitted to customize the view or display of the graph. The graph may or may not be interactive. In some cases, a user may be permitted to interact with the graph to view detailed information. For example, a user may click on a dataset (e.g., Facebook) of the graph to view more details. In some cases, data or metadata associated with a virtual card such as author, time of creation/modification, and the like may also be automatically captured and stored with the virtual card.

A user may add/create cards based on analyses or from external sources. For instance, a user may select an existing analysis or import an analysis for creating a virtual card. Upon receiving a user input indicating creating a new card, a virtual card with an auto-populated graph may be generated and may prompt a user to provide insight/recommendations within the GUI of the virtual card. In some cases, a virtual insight card may also be generated for imported analysis. For example, a user may upload an image or screenshot of an analysis result (e.g., diagram, chart, graph, etc.) and the image may be used to create the virtual card.

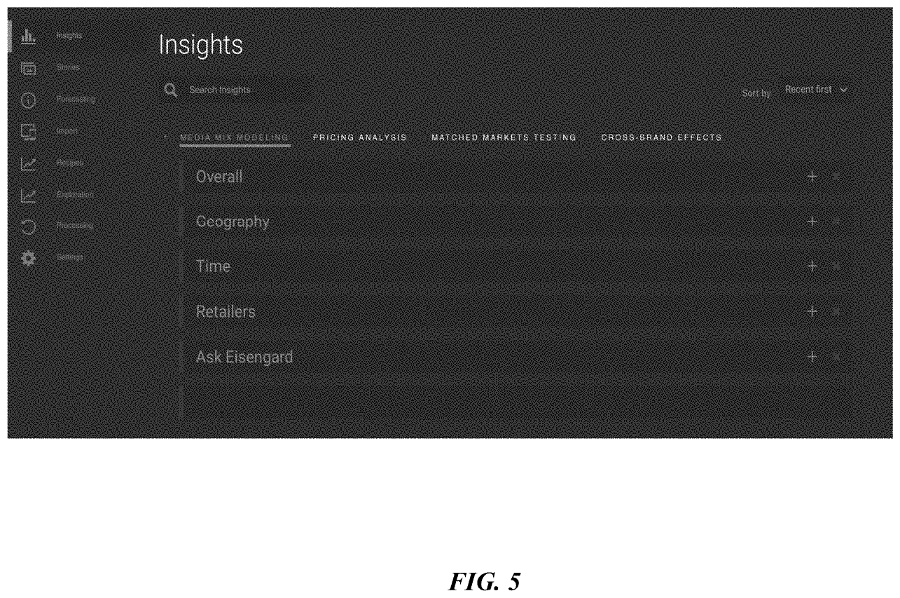

Once an “insight” virtual card is created, it may be organized and stored by the intelligent analytic platform. FIG. 5 shows an exemplary GUI of a insights dashboard for managing and viewing a plurality of “insights” virtual cards. The “insights” may be organized by different categories (e.g., media mix modeling, pricing analysis, matched markets testing, cross-brand effects) and/or sub-categories. Users may swipe through these virtual cards, add/remove cards, edit selected cards, add comments and share selected cards with other entities. Comments can be provided to promote collaboration, conversation, and iteration. Users can add comments by clicking a comments button on the insight dashboard or a selected virtual card.

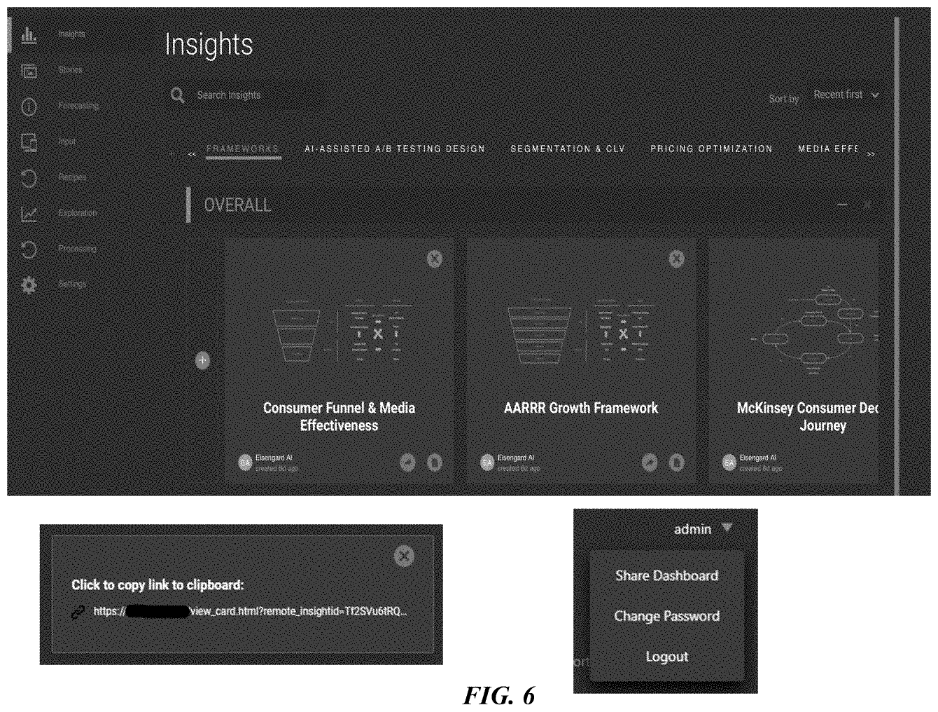

A user can search for virtual cards using any search parameters. For example, keywords, titles, author name, categories, groups, teams, experience, geographic locations, or any other information may be used. The search may occur by entering information into a field (e.g., “search insights”). In other embodiments, filtering may occur using one or more drop down menu, checkbox, or any other user interactive feature. A user may also sort the virtual cards by time (“recent first”), categories or other parameters. A user may be permitted to view a plurality of virtual cards in an “overall” mode such as illustrated in FIG. 6.

FIG. 6 shows an example of sharing a virtual card. The virtual card can be conveniently shared across people, teams, departments, organizations or other entities. As illustrated in the example, the virtual card may be shared via a link. A user may copy a link to the clipboard and share the virtual card/link using any suitable communication channels (e.g., email, chats, text messages, etc.). This allows the virtual cards to be rapidly shared with users within or outside of the platform thereby providing rapid communication and collaboration. In some cases, each of the virtual cards can be selectively assessed by one or more users by enabling permissions to the one or more users. In some cases, an author of a virtual card may set up permissions for other users (who have access to the card) to view and/or edit the card. In some cases, a user may share the entire insights dashboard with others using a dropdown menu. For example, once a user chooses to share the entire insights dashboard with selected individuals, the recipients may receive a link via a communication channel (e.g., email, chats, text messages, etc.) and may access a non-editable, read-only view of the insights section of the shared page.

In some embodiments, a user may create stories using the standard format. A story may include one or more insights cards assembled together. A story may be a lightweight presentation of a project including one or more analyses along with insights stitched together according to a user-defined order. A user may create a story with aid of the provided ‘story’ module.

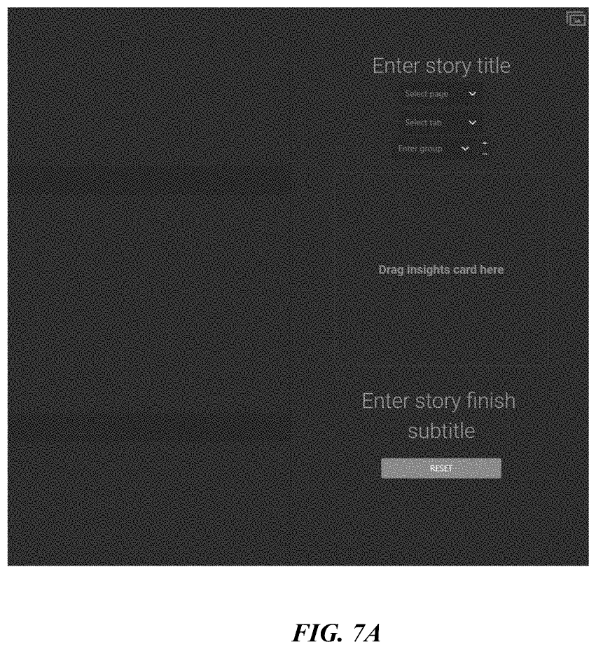

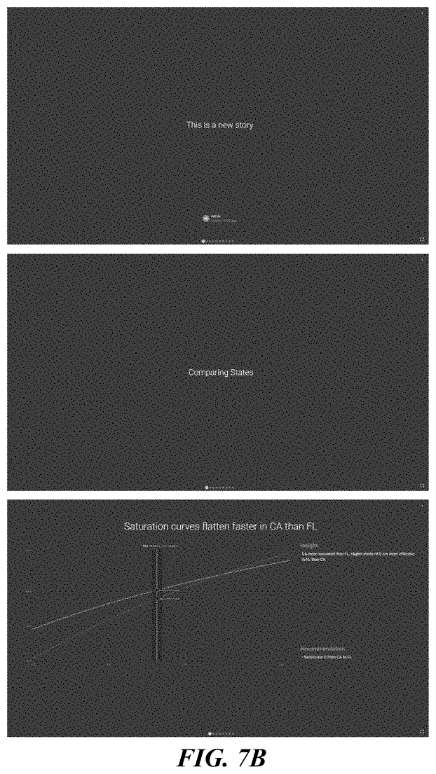

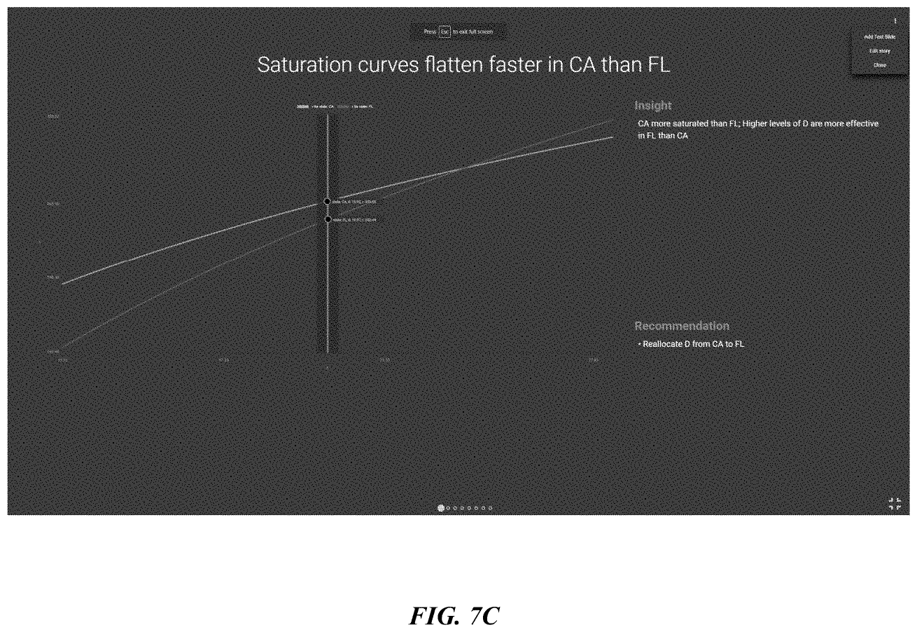

FIG. 7A shows an exemplary GUI for creating a story. The GUI may comprise a story creator panel including editable fields such as story title, and story finish subtitle. The GUI may also include drop-down menus for assigning the story to a selected page, a tab within the page, and a user group. A user may be permitted to add one or more insights cards by drag-drop selected insights cards to the story creator panel. A user may ‘reset’ or ‘finish’ a story by clicking on the reset or finish button. Upon finishing editing a story, a story may be automatically updated and can be accessed under the story section. FIG. 7B shows example “slides” of a lightweight story in fullscreen mode. FIG. 7C shows an example of a slide of a story. The story slide may provide options for switching to an editing mode. For example, a user may click on the icon on the story slide (e.g., top right corner of the story slide) to view a dropdown menu that allows the user to edit the story. If the user clicks on the “Edit story” option, the story may be displayed in a editing mode where the user may edit the story by adding/removing virtual cards, reordering the virtual cards, editing titles, subtitles, and the like similar to the operations in the story creation panel.

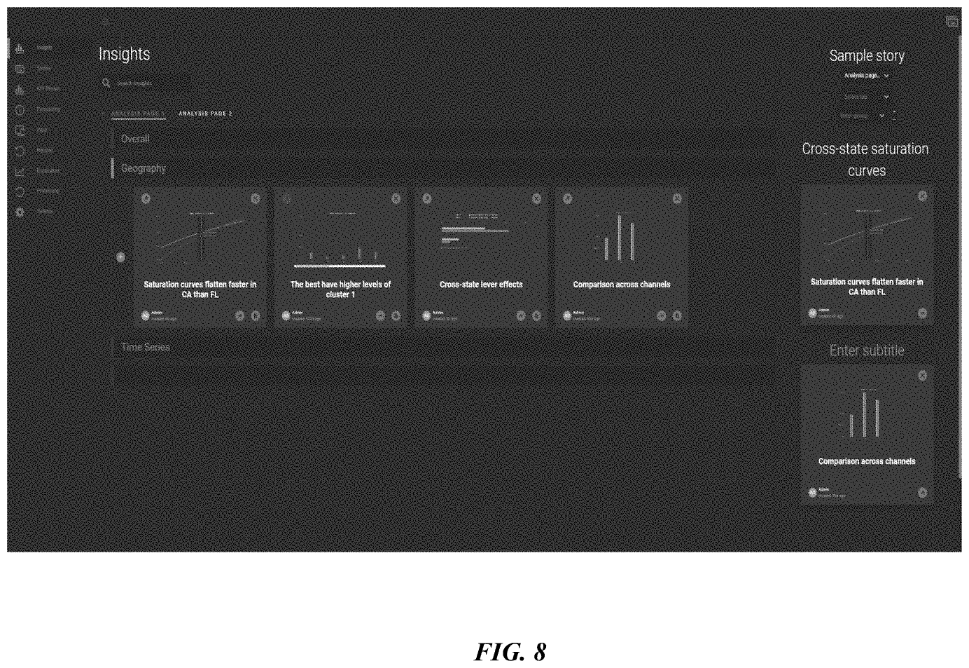

FIG. 8 shows examples of created stories. As shown in the figure, a story may include an assembly of multiple insights cards arranged according to a user-defined order or default order.

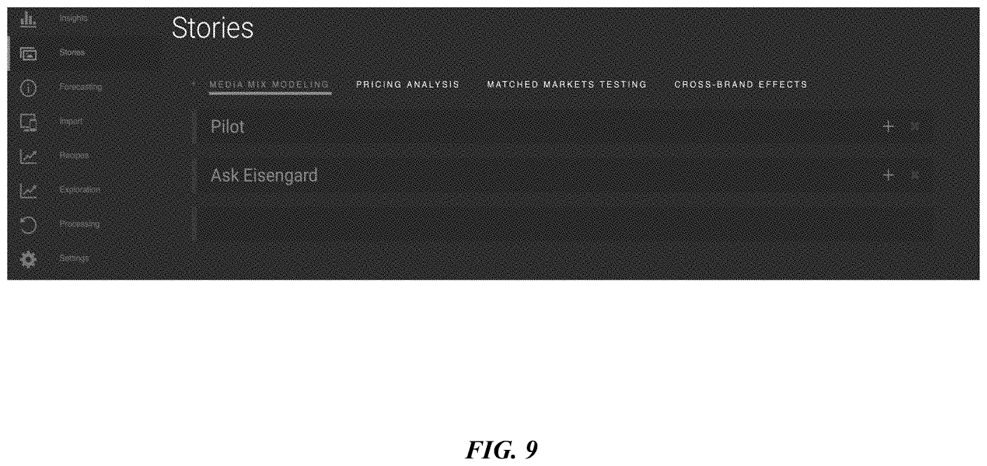

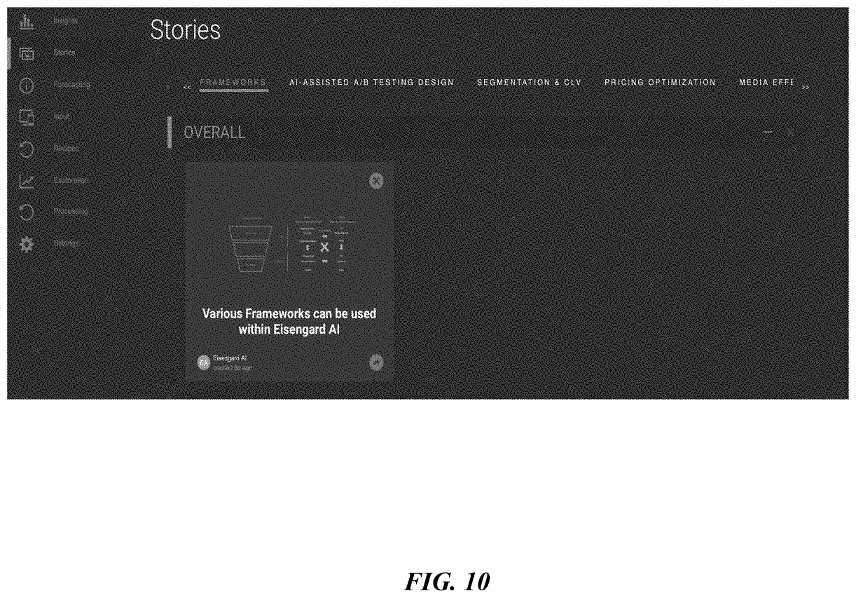

FIG. 9 and FIG. 10 show examples of GUI of story dashboard for managing and organizing stories. The stories may be arranged by categories and/or subcategories. Similarly, users may search and sort stories within the story dashboard. A story can also be shared with others in a similar manner as described above. The insight and story dashboard may also permit users to provide real-time feedback to the intelligent analytic system (e.g., ‘Ask Eisengard’).

In some cases, the virtual card for the insight or the story may include interactive visual components such as animation or animatable elements. For instance, when a user clicks on a given component (e.g., graph), it may flip over to the back to display additional information.

### Real-Time Streaming of Statistics and Customizable Dashboard

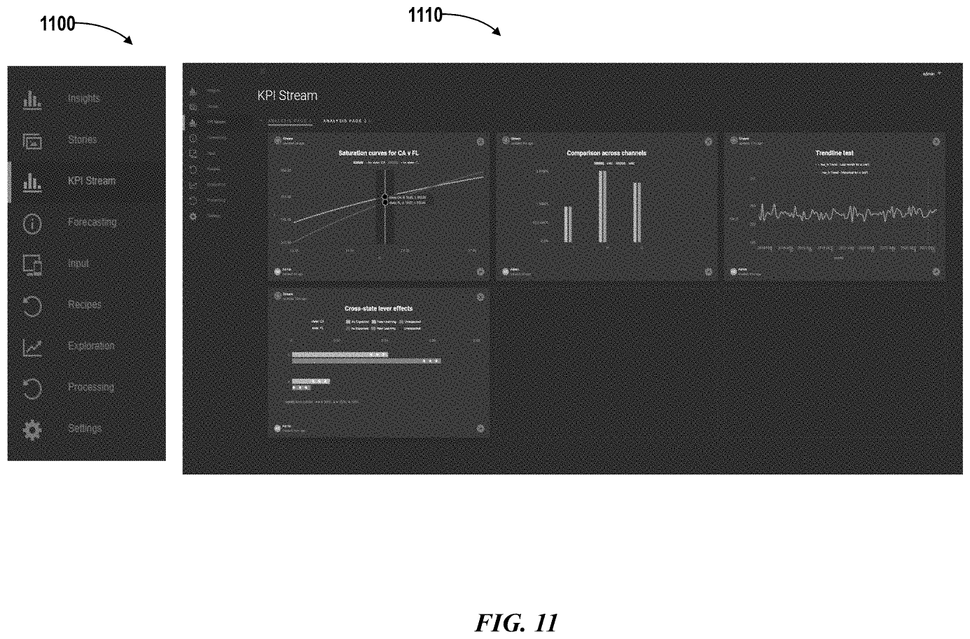

In some embodiments, the intelligent data analytic platform may comprise a module allowing users to create and/or customize their own dashboards. For example, a user may select analyses of interest for tracking in real-time. In some cases, the intelligent data analytic platform may also provide real-time streaming of key performance indicator (KPI) as an output of one or more complex analyses (e.g., regression coefficients of different levers, saturation curves, optimization output, etc.). A user may, for example, add the KPI streamlining component to a user created dashboard to track the real-time KPI measurements. FIGS. 11-13 show examples of GUI for customizing KPI streaming and/or dashboard.

FIG. 11 shows examples of GUIs for KPI stream. The KPI stream module can be accessed via the home panel 1100. The KPI stream module may permit users to select one or more analyses for creating the KPI stream dashboard. The KPI measurements may be calculated and updated in real-time. In some cases, the KPI measurements may be recalculated or updated in response to a user input. For instance, upon receiving a user input indicating updating the KPI calculation, the analyses may be re-run on the recent data and the KPI calculation may be updated. In some cases, the KPI may be recalculated or updated automatically upon detection of a change in the data or the analyses.

A user may select one or more analyses for creating the KPI Stream dashboard. The provided intelligent data analytic platform may permit users to create the KPI Stream dashboard by selecting the modular virtual cards. As illustrated in FIG. 11, within the KPI Stream interface 1110, a user may ‘pin’ analyses from the virtual cards. These analyses or the virtual cards can be organized in any suitable arrangement. For example, the virtual cards may be snapped into a grid structure (e.g., 2×3 grid). When a user pins an analysis to the KPI interface 1110, the virtual card may be automatically snapped to an empty slot or placed to a pre-determined coordinate within the region. In some cases, a user may drag-drop a pinned virtual card to change the order of the analyses displayed within the interface 1110. In some cases, when all the slots are occupied, a user may receive a message informing no more slot is available. In some cases, a user may be prompted to create/edit a title for each pinned analysis/virtual card. The title can be edited at any time. A user may also add, remove, edit a selected virtual card within the KPI stream interface.

As described above, in some cases, the KPI Stream dashboard may be updated in response to a user input. For instance, a user may click on an icon (e.g., circular arrows recycle icon) shown on a selected virtual card indicating re-run a selected analysis, then the KPI Stream dashboard or the corresponding virtual card may be updated. In some cases, the KPI may be recalculated or updated automatically upon detection of a change in the data or the analyses. In some cases, a timestamp of the latest update may be shown within the respective analysis/virtual card.

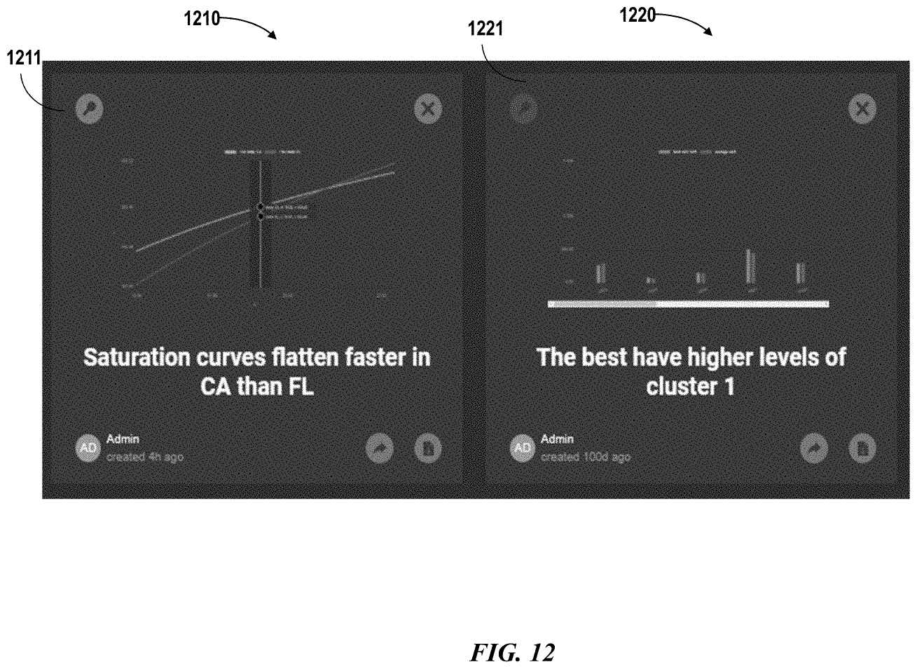

In some case, the virtual card pinned to the KPI Stream dashboard may be based on analysis performed by the intelligent analytic system. Alternatively or in addition to, users may be permitted to pin images/cards of analyses results uploaded to the system. In such case, the card or analysis may not be updated or re-run by the system. FIG. 12 shows examples of virtual cards 1210, 1220 pinned to a KPI Stream dashboard. The virtual card 1210 may correspond to an analysis performed by the intelligent analytic system and the ‘pin’ icon 1211 may be shown as “active.” The second virtual card 1220 may be a screenshot of an analysis result imported to the system. In this case, the ‘pin’ icon 1221 may be greyed out and the virtual card may not be editable.

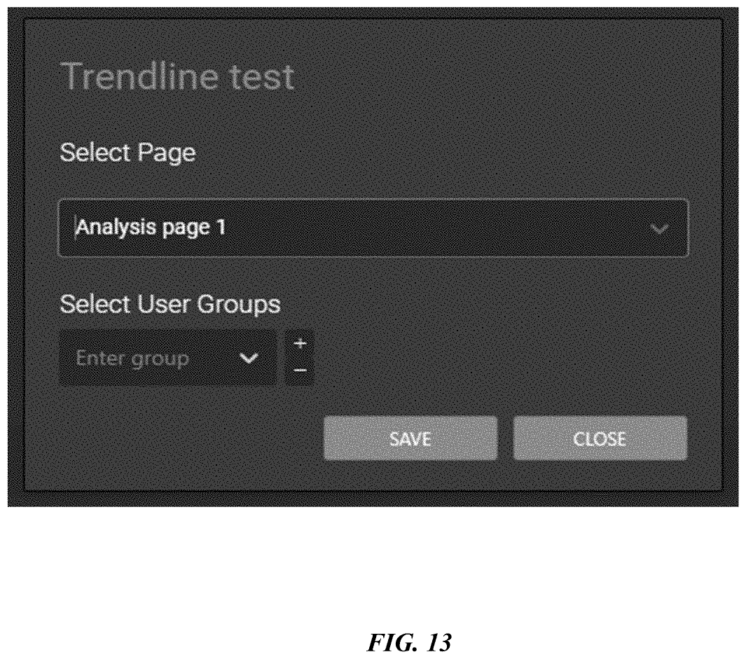

When a user clicks on an active ‘pin’ icon (e.g., icon 1211), a popup window may appear prompting the user to enter a title for the virtual card (e.g., analysis image), select the page, tab, and group. FIG. 13 shows an example of the analysis image creator panel. As illustrated in the example, a user may enter text for the title, select the page and user group from the drop-down menu.

Analytics-Powered System-Level Overview through Frameworks

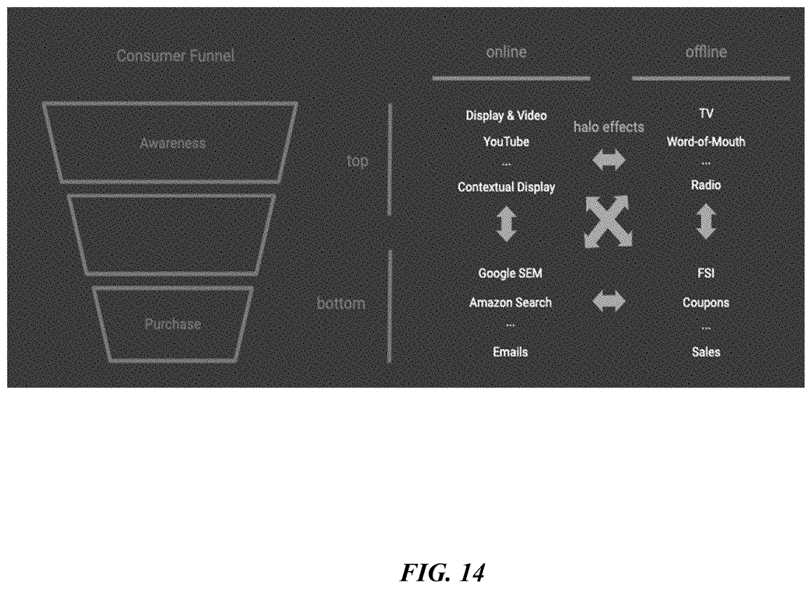

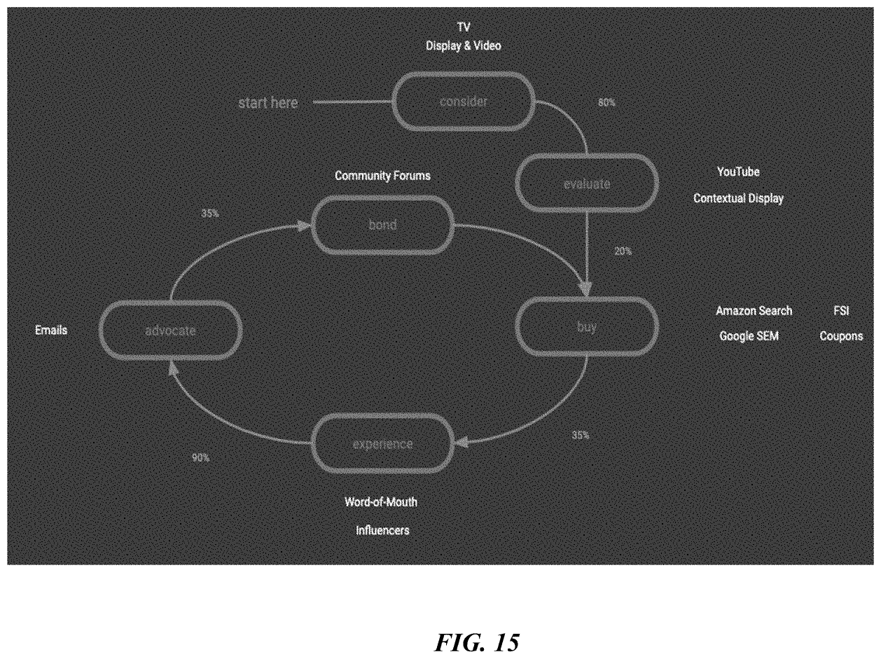

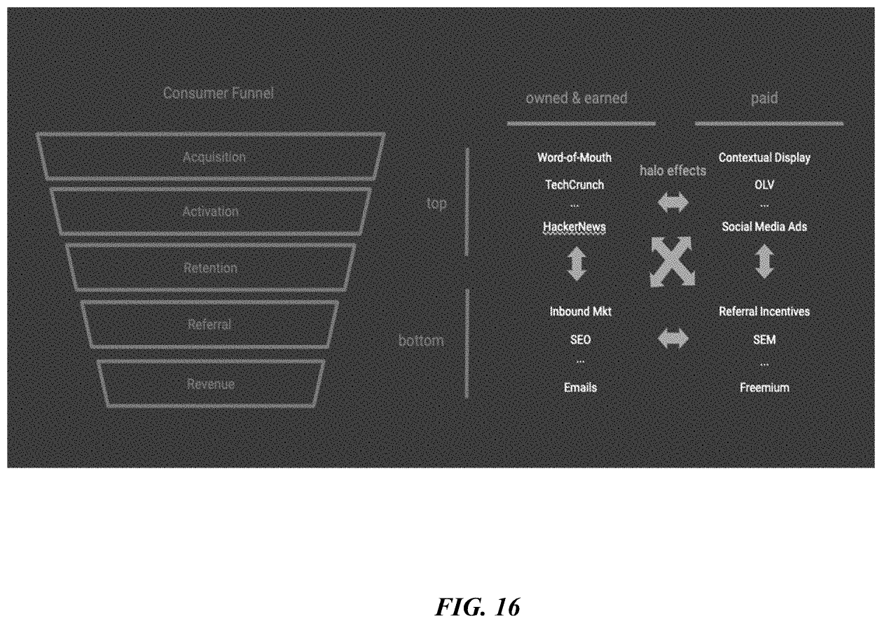

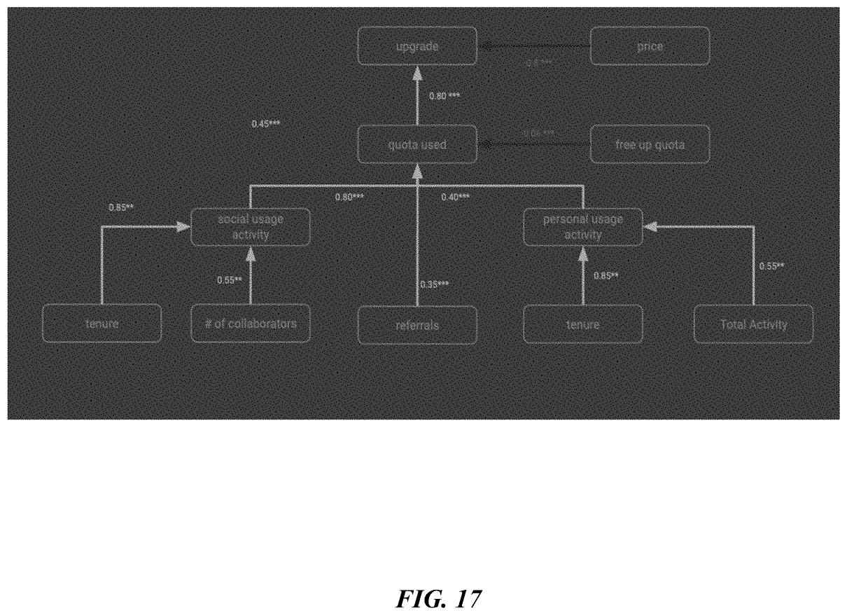

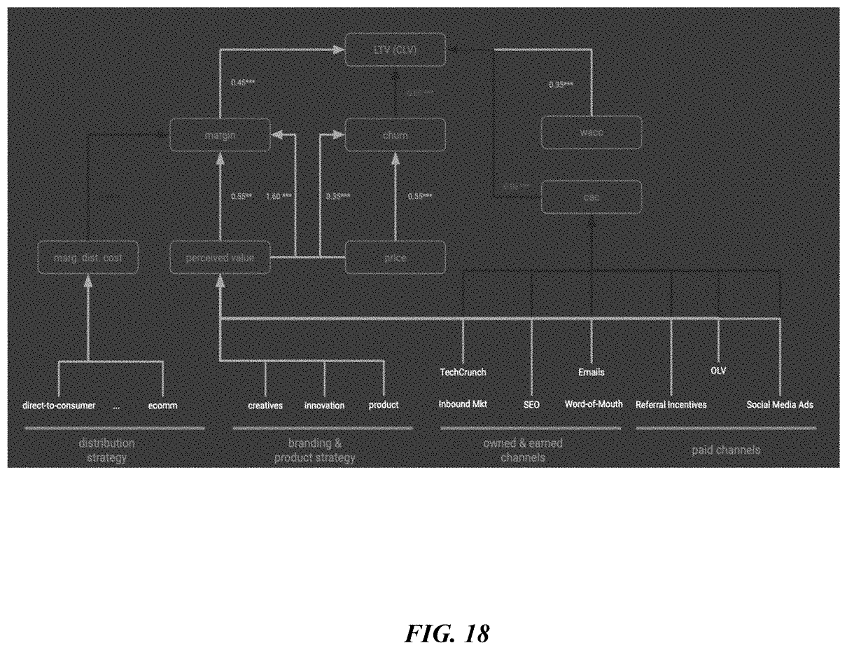

In some embodiments, the intelligent data analytic platform may allow users to integrate their own frameworks to the system regardless the types of frameworks. Various frameworks may be seamlessly integrated to one or more components of the system thereby allowing for user-specific workflow for decision making. FIGS. 14-18 show various examples of frameworks. FIG. 14 shows an example of a consumer Funnel Framework and FIG. 15 shows an example of a McKinsey's Customer Decision Journey Framework. Marketers may prefer to juxtapose channels with consumer funnels or journeys whereas tech companies may prefer a modified funnel framework such as shown in FIG. 16 or a flow-chart to denote the revenue flow system in a Freemium business model as shown in FIG. 17. FIG. 18 shows another different Framework (e.g., CLV framework) that may be used by CPG company designed to tie distribution, branding, and media decisions all the way to the customer lifetime value.

All of the aforementioned frameworks as well as various other frameworks may be supported by the intelligent analysis platform. The intelligent analysis platform may comprise a dashboard feature that allows users to construct their own framework for the purposes of visualizing, tracking, delegating, and communicating their strategic decisions and metrics throughout the entire organization.

The intelligent analysis platform may permit users (e.g., senior manager) to delegate one or more components (e.g., tasks, projects, etc.) of their own framework to other users such as teams who are performing data analyses enabled by the intelligent analytic platform. The teams may utilize the intelligent data analytic platform to create the easy-to-share Insights virtual Cards as described above and link these insights and analyses directly back to the framework to deliver a senior-level management solution. Such framework may be deployed to an environment as described in FIG. 2 or FIG. 3.

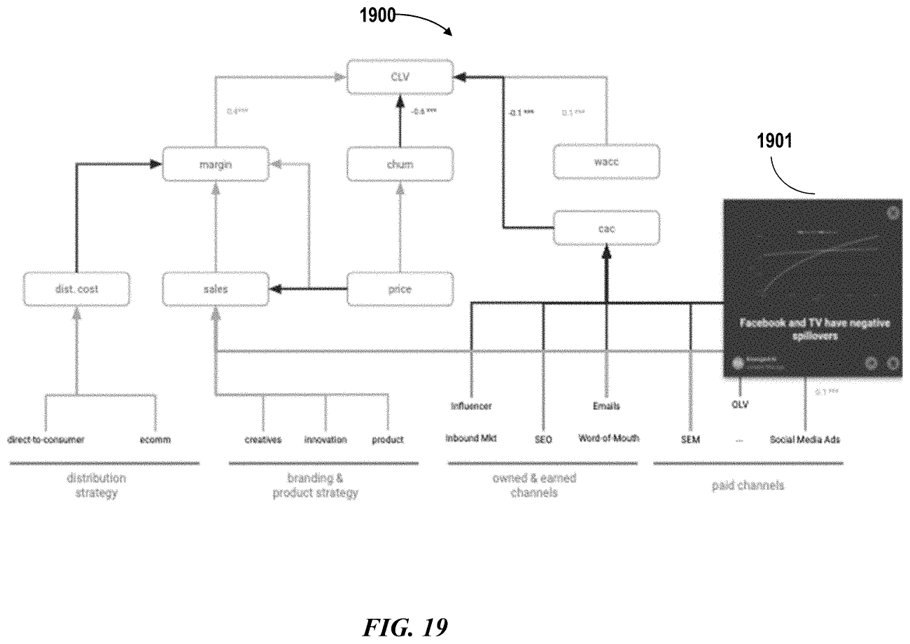

FIG. 19 shows an example of linking one or more insight cards/analyses 1901 to an existing framework 1900. As illustrated in the example, the framework may be provided as an interactive graph representation of a plurality of tasks nodes connected by directional links. A user may be permitted to assign tasks to other people (e.g., assignees) by interacting with the interactive components (e.g., link, tasks nodes) of the framework. For example, a user may delegate a task or project to other people who are part of the system (e.g., team, subordinates, colleagues, etc.) by selecting (e.g., clicking on) a link of the framework. In some cases, upon selection of a link, the user may be prompted to provide the assignee (e.g., user name, team, group, etc.) to delegate the corresponding task. The assignee may receive a task notification via email, in-app alert, or other communication channels. In some cases, a user may set task notification preferences for receiving task notifications. For example, the user may elect to receive task notifications via e-mail, via the alert icon, or both.

In some cases, the entire framework may be tested in a distributed fashion by teams, individuals, users across the platform, organizations, departments working collaboratively to fulfill the framework. For instance, the framework may be deployed to an environment as described in FIG. 2 or FIG. 3. In some cases, creation of an insight virtual card or analysis card may indicate completion of a tasks. Once the respective tasks are completed, the data-driven insights virtual cards may be hyperlinked to each one of the links back to the framework. The assignor may view the effectiveness metric, the insight or story by interacting with (e.g., clicking on) the links or tasks nodes of the framework.

As used herein, “or” is inclusive and not exclusive, unless expressly indicated otherwise by context. Therefore, “A or B” means “A, B, or both,” unless expressly indicated otherwise or indicated otherwise by context. Moreover, “and” is both joint and several, unless expressly indicated otherwise or indicated otherwise by context.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An intelligent analytic platform comprising:
an electronic display with a user interface comprising: (i) a plurality of graphical virtual cards corresponding to a plurality of analyses and insights and (ii) an interactive framework;
a memory for storing a set of software instructions, and one or more processors configured to execute the set of software instructions to:
link at least one of the plurality of graphical virtual cards to an interactive component of the framework; and
output an analytic solution of the framework.
